(19) United States
(12) Patent Application Publication
(10) Pub. No.: US 2011/0290695 A1
(43) Pub. Date: Dec. 1, 2011

(54) Consumable Bitumen Film For Packaging Bitumen And Extrusion Process Therefor

(75) Inventor: Gordon William Thomas, Singapore (SG)

(73) Assignee: EPS Offshore Oil Trading PLC, Roseau (DM)

(21) Appl. No.: 13/147,596

(22) PCT Filed: Nov. 19, 2009
(86) PCT No.: PCT/SG2009/000436

§ 371 Date: Aug. 19, 2011

(30) Foreign Application Priority Data
Feb. 3, 2009 (SG) 200900801-2

(51) Int. Cl. B65D 85/00; B28B 11/04

(52) U.S. Cl. 206/524.1; 206/524.6; 425/96

(57) ABSTRACT

The present invention describes a system (100, 100a, 100b) for dispensing and packaging bituminous products into blocks or slabs. Each block/slab of bitumen (200, 200a) is sealed by a bitumen compound film (160). The bitumen compound film (160) is made up of about 10-30% by weight of natural bitumen and about 5-25% by weight of a synthetic rubber polymer and copolymers. The bitumen compound film (160) is melted with the bituminous product and is fully compatible with the molten bitumen, leaving no residue but enhances the physical properties of the resultant bitumen mixture.

### FIELD OF INVENTION

The present invention relates to a consumable bitumen compound film for packaging bituminous products in cold form and its associated extrusion process. In particular, the invention relates to encapsulating or packing of bitumen with a bitumen compound film that is consumable or meltable and compatible with the bituminous content.

### BACKGROUND

Bitumen (in some countries is also known as asphalt) is used mainly as a binder in road construction with a small percentage being used in roofing/waterproofing and vibration/anti-corrosion materials. Bitumen, including naturally occurring and refined bitumen obtained from distillation of crude oil, is usually semi-solid at room temperature and liquid when heated up. Conventionally, bitumen is stored and transported in bulk via tanks, pipes, trucks and ships that are maintained at elevated temperature of around 120 to 160° C. (ie. heated form), or at normal ambient temperature in steel drums or in polyethylene, polypropylene or paper bags (ie. cold form).

Storing bitumen in heated tanks and vessels consumes energy, thus making it expensive, whilst storing bitumen cold in drums leads to wastage as bitumen is very viscous and leaves behind residues. For example, the residues in steel drums may amount to about 3%. Packing of bituminous products in polyethylene, polypropylene or paper bags often leads to leakages during handling and transporting. With greater environmental concern, there is therefore a need for another method of packing, storing and transporting bitumen and bituminous materials in the cold form.

Further, handling and transporting of bituminous products in, for example 200 litres, steel drums can be difficult and hazardous if specialized drum handling equipment is not available at the transporter or end-user site.

US patent publication no. 2007/0027235, by Albert Marchal describes a consumable bitumen packaging material. The packaging material is made of a mouldable composition composed of 60.1-99.9 weight % of polymer, with 0.1-39.9% of said proportion is bitumen, and 0.1-39.9 weight % of a metallic charge. A packing container is moulded and after cooling it is filled with bitumen in a separate operation. The density of the packaging material is adjusted so as to prevent the packaging material from floating to the surface of the molten bitumen. The packaging material also has the required toughness, impact resistance and temperature stability for storage and transport.

Despite development in consumable bitumen packaging, there is still a need for another way of packaging bituminous materials in the cold form yet is clean safe, eco-friendly, energy saving and cost effective.

### SUMMARY

The following presents a simplified summary to provide a basic understanding of the present invention. This summary is not an extensive overview of the invention, and is not intended to identify key features of the invention. Rather, it is to present some of the inventive concepts of this invention in a generalised form as a prelude to the detailed description that is to follow.

In this document, bitumen and bituminous materials include the semi-solid hydrocarbon product produced by refining of crude oil, petroleum pitches produced by cracking of petroleum fractions, tar produced from coal and natural occurring bitumen. In North America, asphalt is synonymous to bitumen; outside North America, asphalt refers to a mixture of bitumen and aggregates for road construction.

In one embodiment, the present invention provides a new way of packaging bitumen. Accordingly, a bitumen package comprises: a bituminous material being formed into a block; and a bitumen compound film operable to encase the bituminous block; wherein said bitumen compound film comprises substantially 10 to 30% by weight of natural bitumen, substantially 5 to 25% by weight of a synthetic rubber polymer and the balance being the bituminous material of said block.

In another embodiment, the present invention provides a system for extruding and packaging bitumen. The system comprises: an extrusion head having a die, said die has a core output channel and a film output channel surrounding the core output channel; wherein: a bituminous material is operable to be extruded through the core output channel whilst a bitumen compound film is operable to be extruded through the film output channel so that the bitumen compound film is formed around a core of the bituminous material. In one embodiment, the bitumen compound film comprises 10 to 30% by weight of natural bitumen, 5 to 25% by weight of synthetic rubber polymer and the balance being the bituminous material of the core.

In one embodiment of the above system, it comprises a weld press; in another embodiment, it comprises bitumen compound extruder in the form of a gear pump and a bituminous material extruder; in yet another embodiment, it comprises a mixing and cooling tank for supplying bituminous material to the bituminous material extruder. In any one of the above embodiments, it comprises a water bath disposed downstream of the weld press.

### BRIEF DESCRIPTION OF THE DRAWINGS

This invention will be described by way of non-limiting embodiments of the present invention, with reference to the accompanying drawings, in which:

FIG. 1A illustrates a system for extruding bitumen into blocks and encapsulating each block in a bitumen film according to an embodiment of the present invention; FIG. 1B is a schematic of the system 100 shown in FIG. 1A;

FIG. 2A illustrates a bitumen pack according to another embodiment of the present invention, whilst FIG. 2B illustrates an end view and FIG. 2C illustrates a sectional view; and

FIG. 2D illustrates a bitumen pack with all sides of the bitumen compound film being sealed up;

FIG. 3A illustrates pallets with stacks of bitumen packs shown in FIG. 2A;

FIG. 3B illustrates a shipping container with pallets of bitumen packs; FIG. 3C illustrates a shipping container loaded with bitumen packs without using pallets;

FIG. 3D illustrates a lifting bag containing stacks of bitumen packs;

FIG. 3E illustrates another lifting bag containing bitumen packs; and

FIG. 3F illustrates stacks of bitumen packs in storage.

FIG. 4 illustrates a mixing and cooling tank for supplying bitumen to the bitumen extruder shown in FIG. 1A;

FIG. 5A illustrates a piston-type bitumen extruder according to another embodiment of the present invention;

FIG. 5B illustrates a screw-type bitumen extruder according to yet another embodiment; and FIG. 5C shows a sectional view of the extrusion head for use with the present invention.

### DETAILED DESCRIPTION

One or more specific and alternative embodiments of the present invention will now be described with reference to the attached drawings. It shall be apparent to one skilled in the art, however, that this invention may be practised without such specific details. Some of the details may not be described at length so as not to obscure the invention. For ease of reference, common reference numerals or series of numerals will be used throughout the figures when referring to the same or similar features common to the figures.

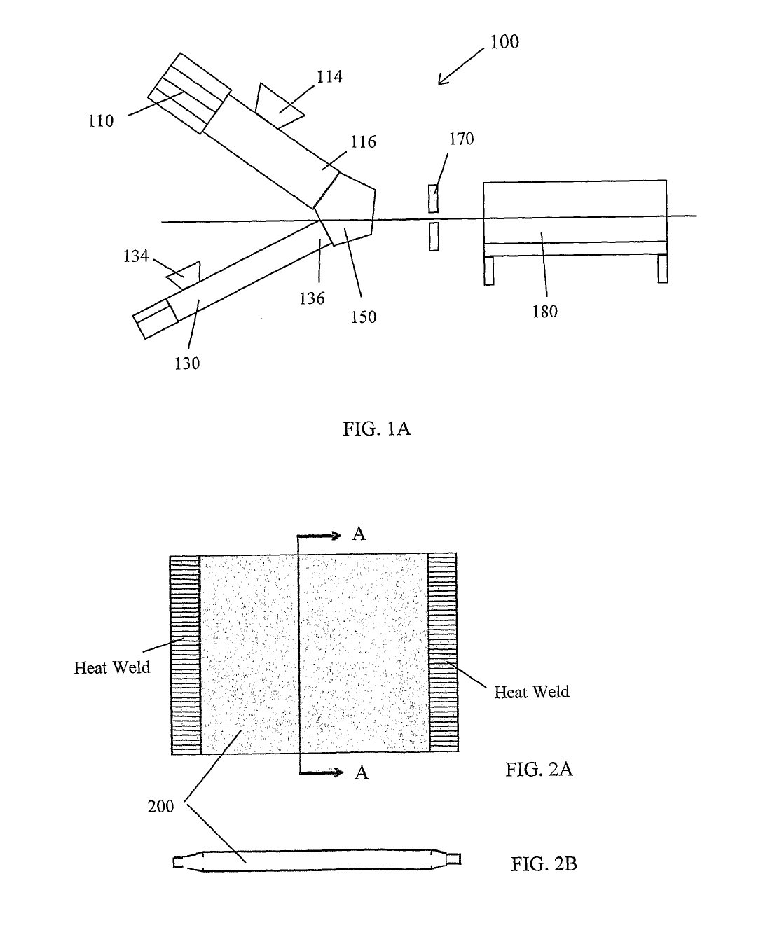

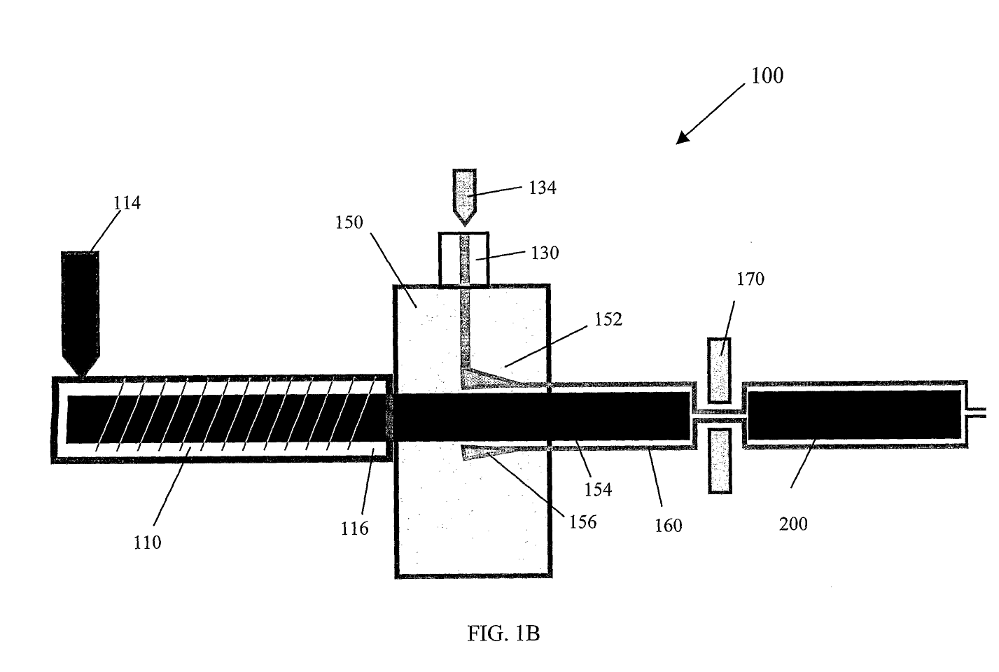

FIG. 1A shows a system 100 for co-extruding bitumen and bitumen compound film according to an embodiment of the present invention, whilst FIG. 1B shows a schematic of the system 100. As shown in FIGS. 1A and 1B, the system 100 includes a bitumen extruder 110, a bitumen compound film extruder 130, an extrusion head 150, a weld press 170 and, optionally, a cooling unit 180. In the system 100, a bitumen product is extruded or dispensed into blocks 200 and each block is encapsulated or encased in a bitumen compound film 160 in one operation.

In one embodiment, the bitumen extruder 110 is a rotary screw extruder. In another embodiment, the bitumen extruder is a piston-type injection extruder. The bitumen extruder 110 has an inlet hopper 114 and an output end 116. Similarly, the bitumen compound film extruder 130 may be a rotary screw or piston-type extruder, which has an inlet hopper 134 and an output end 136. For example, road paving grade bitumen at about 40° C. to about 200° C. is fed into the inlet hopper 114 of the bitumen extruder 110, whilst the bitumen compound film 160 composition, also at about 160° C. to about 200° C., is fed into the inlet hopper 134.

As shown in FIGS. 1A and 1B, the output ends 116, 136 of the bitumen and bitumen compound film extruders are connected to the extrusion head 150 such that bitumen is extruded through a centre core 154 of a die 152 whilst a tube of bitumen compound film 160 is extruded through a channel 156 surrounding the centre core 154. In use, a bitumen compound film 160 is co-extruded to surround a block of extruded bitumen to form a pack 200. At the discharge end of the die 152 is a weld press 170 for sealing the bitumen compound film 160 separately at a front end and rear end of each pack of extruded bitumen. Each extruded bitumen pack 200 may then be transferred through the cooling unit 180 before the bitumen pack 200 is removed for storage or delivery.

In another embodiment of the extruder, be it the bitumen extruder 110 or bitumen compound film extruder 130, the extruder may include a high pressure pump system. The high pressure pump system, for example, in the range from about 10 bar to 200 bar is to provide sufficient force to extrude the bitumen through the centre core 154 of the die 152 or the bitumen compound film 160 through the channel 156 surrounding the centre core 154 of the die 152.

In one embodiment of the present invention, the bitumen compound film 160 is made up of 10-30% by weight of natural bitumen (sometimes known as Gilsonite or asphaltene) and 5-25% by weight of synthetic rubber polymer, and has a melting point of about 100° C. to about 180° C. (Gilsonite is a trade name of American Gilsonite Co., Ltd.). For example, to pack road paving bitumen, such as penetration grades 30 to 100, the bitumen compound film 160 may be made up of 10-30% by weight of natural bitumen, 50-80% by weight of bitumen and 5-25% by weight of synthetic rubber polymer. In another example, to pack polymer modified bitumen (PMB) and roofing/sealing grade bitumen, the bitumen compound film 160 may be made up of 10-30% by weight of natural bitumen and 50-80% by weight of polymer modified bitumen (PMB). In one embodiment, the synthetic rubber polymer and polymer modifier may include styrene-butadiene-styrene (SBS), styrene-butadiene rubber (SBR) and similar rubber grafted polymers and copolymers.

As one will appreciate, the bitumen compound film 160 comprises primarily of the bitumen product that is being packed. With the core of the bitumen product representing about 75% to about 98% of the total material extruded, the bitumen compound film 160 is fully miscible with a melt of the bitumen product. In addition, the relatively small amount of synthetic rubber polymer enhances the properties of the bitumen product without significantly increasing the cost of the packed bitumen blocks 200; for example, when the packed bitumen is used as paving for roads, the bitumen compound film 160 enhances the bitumen by giving it extra durability, resistance to rutting and good gripping surface for tyres.

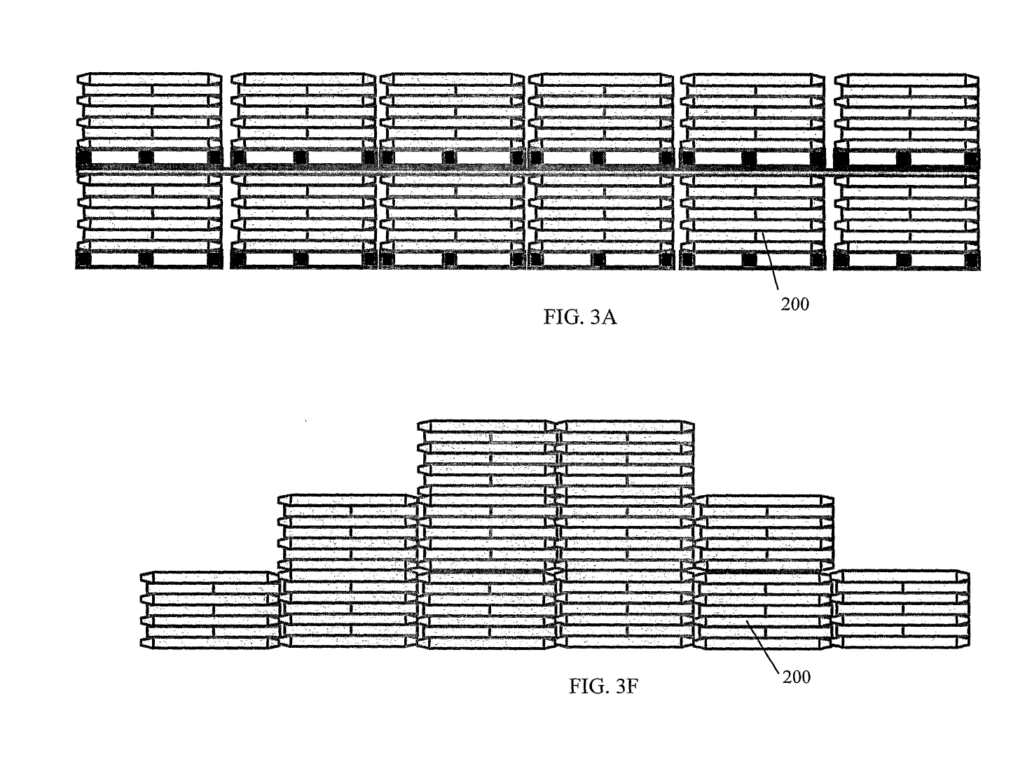

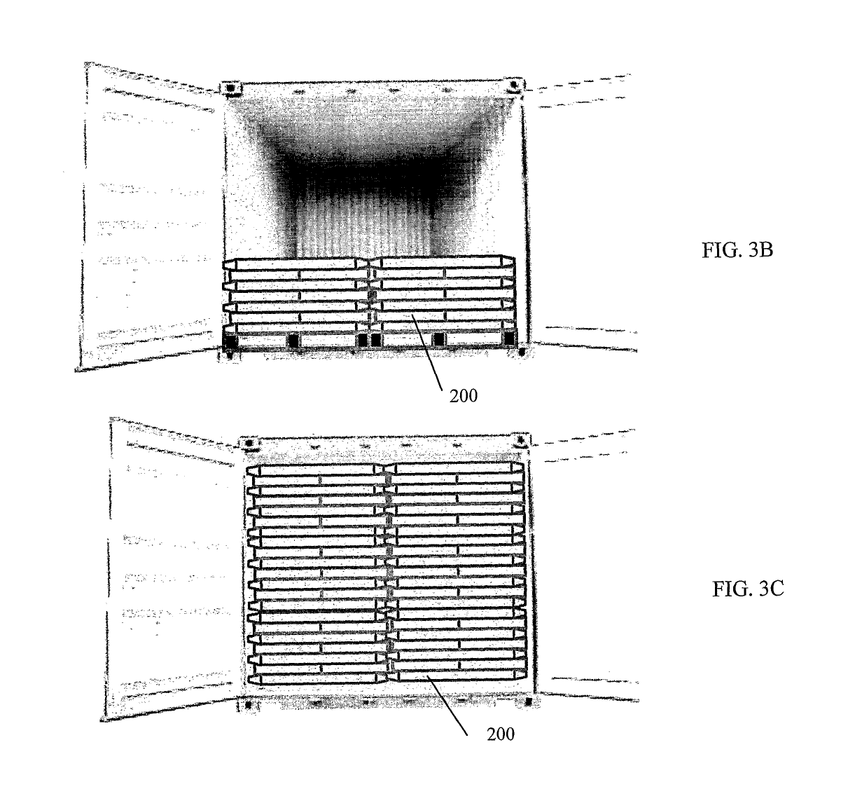

Preferably, the bitumen blocks 200 are extruded in different sizes and weights. For example, for easy manual handling by a person, a packed bitumen block 200 may range from about 1 kg to about 25 kg, whereas a bitumen block of 25-50 kg may be manageable by two persons. For mechanized handling, a packed bitumen block 200 may range from about 50 kg to about 200 kg. These packed bitumen blocks 200 may be stacked on pallets (as shown in FIG. 3A) and in cartoons for delivery by a lorry or in a shipping container (as shown in FIGS. 3B and 3C) for delivery by road, sea or rail, and so on. These packed bitumen 200 may also be packed in lifting bags (as shown in FIGS. 3D and 3E) for loading into lorries, shipping containers, general dry cargo ships, etc. In storage (as shown in FIG. 3F), powder of calcium carbonate, for example, may be sprinkled on surfaces of the packed bitumen blocks 200 to minimize or prevent them from sticking to adjacent bitumen packages. In another alternative, sheets of paper or plastics are used between bitumen packages to minimize them from sticking to each other.

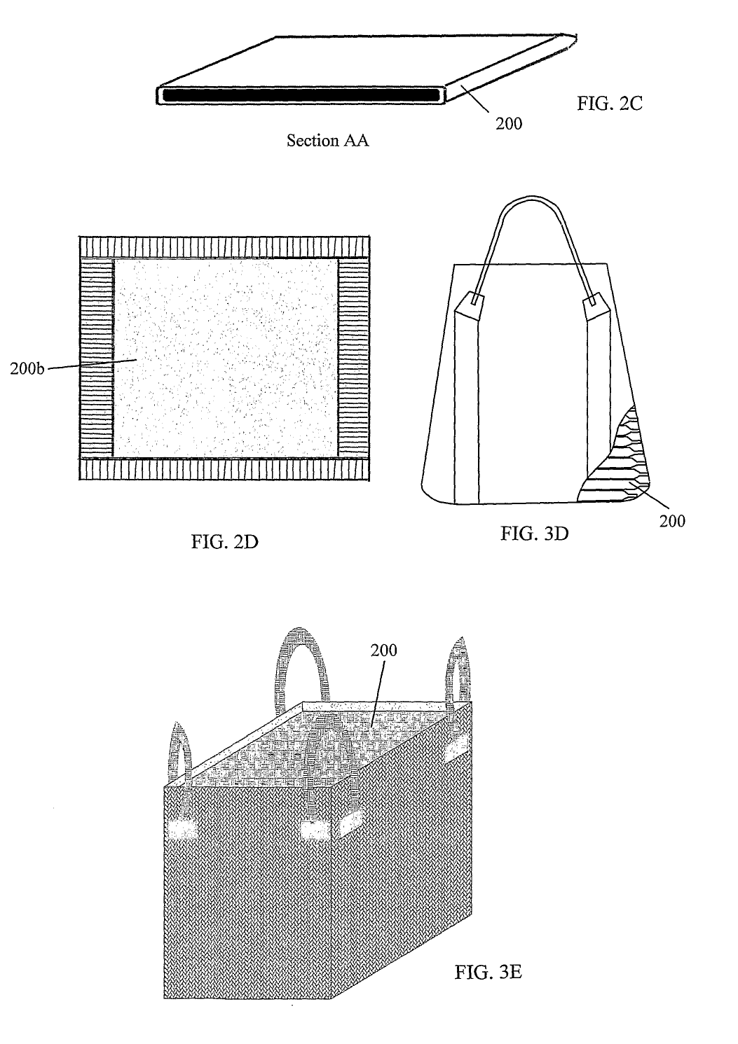

In one embodiment, each block of bitumen package 200 is formed into a slab 200a. Preferably, the bitumen slab 200a has length, width and thickness dimensions, in which the width/length to thickness aspect ratio is about two times or more. FIG. 2A shows a bitumen package 200,200a after it is formed by the co-extrusion system 100. These slabs 200,200a of bitumen, therefore, has a large surface area to volume ratio and thus allows a packaged bitumen slab 200a to melt quickly when heated up in a cauldron. In addition, a vessel of molten bitumen, obtained by melting many of these packed slabs 200a, is homogenous and therefore any required agitation/mixing is minimal. In contrast, the melt down with conventional polyethylene and polypropylene bags results in these polymers floating on the surface of the molten bitumen and it is difficult to disperse these polymers into the molten bitumen.

Depending on the grade of bitumen to be packed and size of each package 200, 200a, the bitumen compound film 160 may range from a thickness of about 200 microns to about 5 mm. For example, for a 5-kg pack of 60-70 or 80-100 penetration grade bitumen, a bitumen compound film 160 thickness of about 200 microns is found to be sufficient; for a 200-kg pack of similar grade of bitumen, the thickness of the bitumen compound film 160 is about 5 mm.

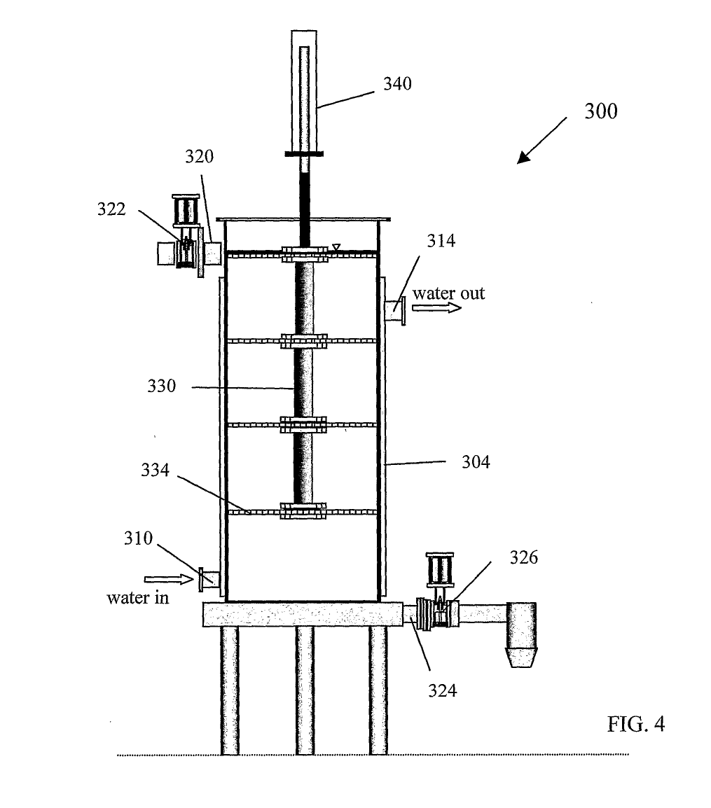

FIG. 4 shows a bitumen mixing and cooling tank 300 for use with the above bitumen extruder 110. As shown in FIG. 4, the mixing and cooling tank 300 includes a double walled, upright vessel. Cooling water is supplied to an outer jacket 304 via a water inlet 310 located near the bottom of the tank 300 and exits through a water outlet 314 located near the top of the tank. Near the top of the tank 300 and above the outer jacket 304, a bitumen inlet 320 allows hot, flowable bitumen to enter the core of the tank 300. Connected to the bitumen inlet is a valve 322, such as a gate valve. Inside the core of the tank, there is a ram 330 with multi-pistons 334. The ram 330 and pistons 334 are operable to oscillate within the interior of the tank 300 to agitate the bituminous content in the tank to increase heat transfer to the cooling water. Oscillation of the ram-pistons is actuated by a driver 340, such as a fluid cylinder. Near the bottom of the tank, the bituminous content of the tank has cooled down and is discharged through a bitumen outlet 324. Connected to the bitumen outlet 324 is an outlet valve 326, such as a gate valve. Discharge of the cooled bitumen may be carried out by synchronising the opening the bitumen outlet valve 326 and the pushing of the ram and pistons. Alternatively, a pump may be supplied after the bitumen outlet valve 326. The cooled bitumen is then supplied to the bitumen extruder 110.

Depending on the bitumen product, the bituminous product is fed into the mixing and cooling tank 300 at a temperature of up to about 180° C. and the cooled bitumen is supplied to the extruder 110 at a temperature as low as about 40° C.

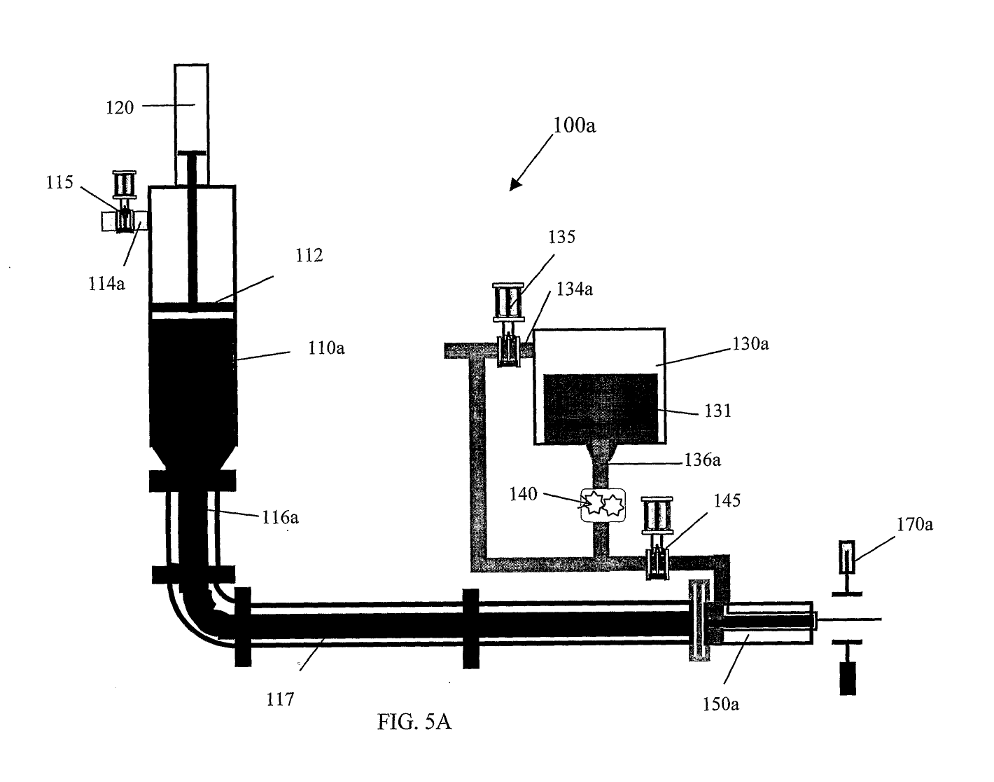

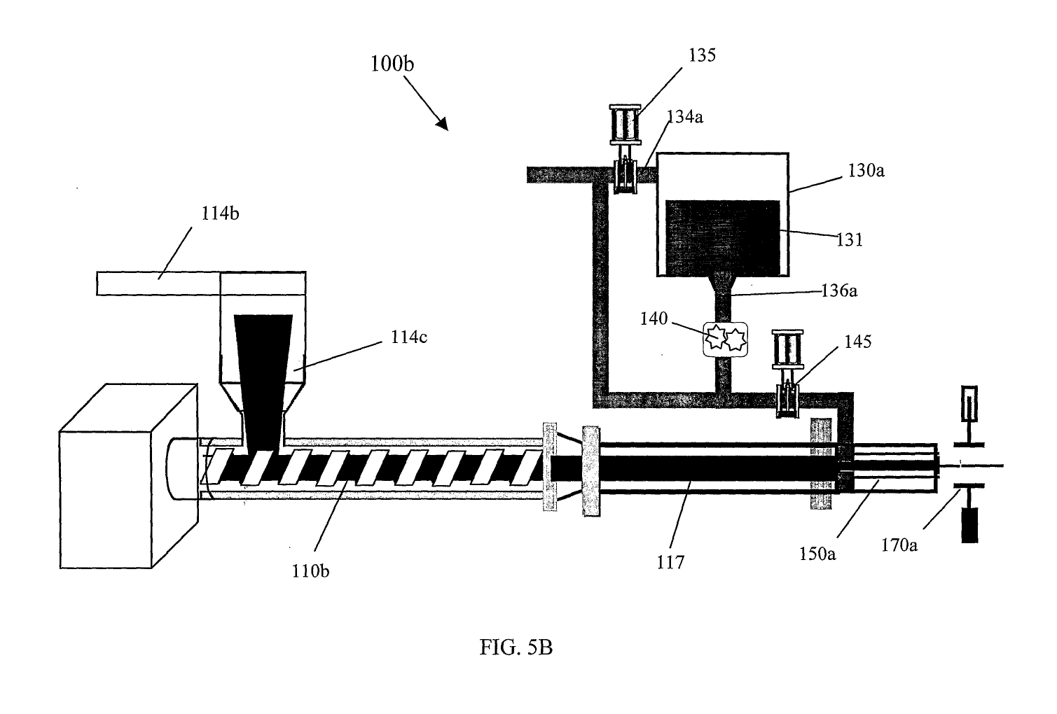

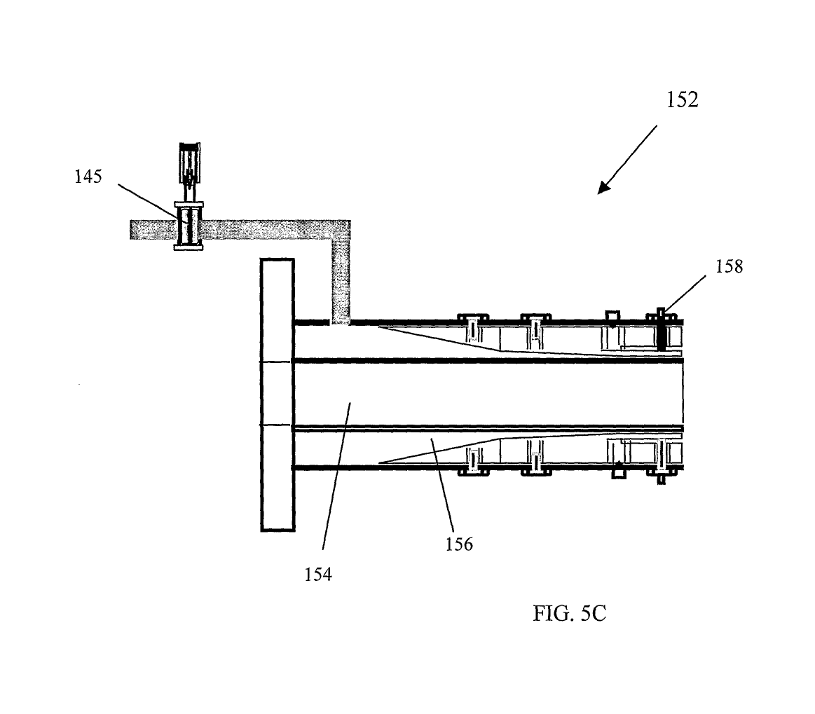

FIG. 5A shows a system 100a for co-extruding bitumen and bitumen compound film according to another embodiment of the present invention. As shown in FIG. 5A, the system 100a includes a piston-type extruder 110a and a bitumen compound film extruder 130a being connected to an extrusion head 150a. The piston-type extruder 110a has an internal chamber in which a piston 112 is operated to translate to and fro. Bituminous product from the mixing and cooling tank 300 is fed into the piston-type extruder 110a via an inlet 114a. Before the inlet 114a, an inlet valve 115 is connected thereto. The piston 112 is operated by an actuator 120, such as a fluid cylinder. As shown in FIG. 5A, the outlet 116a of the extruder is joined by a forming and cooling barrel 117 to the core 154 of the extrusion die 152 disposed in the extrusion head 150a.

Referring again to FIG. 5A, the bitumen compound film extruder 130a has a barrel 131 to contain the bitumen compound. The bitumen compound is pumped or poured into the barrel 131 through an inlet 134a, for example, via a gate valve 135. At the outlet 136a from the barrel 131, there is a gear pump 140. The gear pump 140 is operated to supply the bitumen compound at a pressure of up to 200 bar to the channel 156 of the die 152 to form the bitumen compound film 160. Between the gear pump 140 and the extrusion head 150a is a control valve 145. As shown in FIG. 5A, the outlet at the gear pump 140 branches out at a point between the gear pump 140 and control valve 145 to the inlet 134a. When the control valve 145 is shut, the gear pump recirculates the bitumen compound back into the barrel 131.

FIG. 5B shows a system 100b for co-extruding bitumen and bitumen compound film according to yet another embodiment of the present invention. As shown in FIG. 5B, the system 100b is similar to the previous system 100a except that the extruder 110b is a screw-type extruder; at the inlet 114b to the screw-type extruder, the pressure of the bitumen product is controlled by a pressure regulator 114c.

FIG. 5C shows a section view of an extrusion head 150,150a. As shown in FIG. 5C, the core 154 of the extrusion die 152 is disposed at the centre of the die while the channel 156 surrounds the core 154. As can be seen in FIG. 5C, the outlet opening of the channel 156 is adjustable, for example from about 200 micron to about 5 mm by a set of adjustment screws 158.

At the end-user site, the packed bitumen 200,200a is heated to a temperature of about 150° C. to about 200° C. to melt both the bitumen and the bitumen compound film 160. An advantage of the present invention is that the bitumen compound film 160 is totally compatible and miscible with a melt of the bitumen product. The composition of the bitumen compound film 160 goes into the bitumen content and there is no residue, material wastage or environmental waste. In addition, the natural bitumen and the synthetic rubber polymers/copolymers in the bitumen compound film 160 enhance the physical properties of the bitumen, possibly due to the high molecular mass and long chain polymers of the natural bitumen creating crosslinks in the resultant bitumen mix. For example, the composition of the bitumen compound film 160 may increase the softening temperature of the bitumen mix; bitumen with a higher softening point is advantageous because of its reduced rutting on road surfaces, especially in regions of hot climates.

The method of dispensing and packing bitumen according to the present invention is also safer than conventional methods. For example, this method of dispensing and packaging bitumen poses a lesser occupational hazard to an operator. For example, when extruding road paving grade bitumen, the extruded bitumen is about 40° C. to about 60° C., whereas in conventional methods, bitumen is packed at about 100-160° C. When extruding polymer modified bitumen (PMB), the extruded bitumen is about 90° C. to about 110° C., compared to temperatures of about 160-180° C. for conventional methods.

The other advantage according to the present invention is that dispensing of the bituminous product and encapsulating it in a bitumen compound film are carried out simultaneously, i.e., in one operation. In contrast, the conventional filling of bitumen products in drums, polyethylene, polypropylene or paper bags involve several steps and these lead to unnecessary multiple handling. Hence, the present method is faster and operable at a higher volume than convention methods. This method of dispensing and packing bitumen according to the present invention is, therefore, superior, more economical and effective energy saving than known methods.

While specific embodiments have been described and illustrated, it is understood that many changes, modifications, variations and combinations thereof could be made to the present invention without departing from the scope of the present invention. Whilst the bitumen blocks 200,200a are described broadly to contain paving, roofing and waterproofing materials, the bitumen products are not so limited but include other bituminous compounds, such as: tars; pitches obtained from bottom residues of petroleum refineries; asphalts; industrial bitumen; and bitumen emulsions. In the above description, the bitumen blocks/slabs 200,200a and bitumen compound film 160 are co-extruded; it is possible that the bitumen product is dispensed into moulds, allowed to cast into shape and cooled down before each bitumen block or slab is encased by the above bitumen compound film 160. It is also possible that the above bitumen compound film 160 is extruded into separate sheets; for example, two sheets of bitumen compound films 160 are extruded to cover a bitumen block/slab and all the edges of the bitumen compound film are heat sealed to encase the bitumen block/slab 200b, as shown in FIG. 2D. It is also possible to coat each bitumen block with the above bitumen compound film, for example, by dipping or spraying. In another example, a pair of weld presses 170 may be used to simultaneously heat seal the front and rear edges of a bitumen pack; it is also possible to employ a weld press to simultaneously heat seal all the edges of a bitumen pack in one operation.

1. A bitumen pack comprising:
a bituminous product being formed into a block; and
a bitumen compound film operable to encase the bituminous block;
wherein said bitumen compound film comprises substantially 10 to 30% by weight of natural bitumen, substantially 5 to 25% by weight of a synthetic rubber polymer and the balance being the bituminous material of said bituminous block.

2. A bitumen pack according to claim 1, wherein the bituminous product is any one of the following: road paving grade bitumen or asphalt; polymer modified bitumen; roofing grade bitumen; sealant and waterproofing grade bitumen; emulsion bitumen; tar; and refinery bottom residual pitches.

3. A bitumen pack according to claim 1, wherein said bituminous block is formed into a slab, whose width/length to thickness aspect ratio is substantially two times or more.

4. A bitumen pack according to claim 1, wherein said synthetic rubber polymer comprises its copolymer and similar rubber grafted polymer.

5. A bitumen pack according to claim 1, wherein a bitumen pack weighs from substantially 5 kg to substantially 200 kg and the corresponding bitumen compound film has a thickness of substantially 200 micron to substantially 5 mm.

6. A bitumen pack according to claim 1, wherein the bituminous product constitutes from substantially 75% to substantially 98% of bituminous material in each bitumen pack.

7. A system for dispensing and packaging bitumen in one operation, said system comprising:
an extrusion head having a die, said die has a core output channel and a film output channel surrounding the core output channel;
wherein a bituminous material is operable to be extruded through the core output channel whilst a bitumen compound film is operable to be extruded through the film output channel so that the bitumen compound film is formed simultaneously around a core of the bituminous material.

8. A system according to claim 7, wherein outlet width of the film output channel is adjustable by a set of adjustment screws to give a film thickness range of substantially 200 microns to substantially 5 mm.

9. A system according to claim 7, wherein the bitumen compound film comprises substantially 10 to 30% by weight of natural bitumen, substantially 5 to 25% by weight of a synthetic rubber polymer and the balance being the bituminous material of the core.

10. A system according to claim 9, wherein the synthetic rubber polymer comprises its copolymer and similar rubber grated polymer.

11. A system according to claim 7, further comprising a weld press, which is operable to heat seal the bitumen compound film after the bitumen core and film are extruded to form a pack of bitumen product.

12. A system according to claim 11, wherein front and rear ends of the bitumen compound film surrounding each pack of bitumen product are separately heat sealed.

13. A system according to claim 11, wherein front and rear ends of the bitumen compound film surrounding each pack of bitumen product are simultaneously heat sealed.

14. A system according to claim 11, wherein all the edges of the bitumen compound film surrounding each pack of bitumen product are simultaneously heat sealed.

15. A system according to claim 7, further comprising:
a bitumen compound extruder connectable to the film output channel of the die; and
a bituminous material extruder connectable to the core channel of the die.

16. A system according to claim 15, wherein the bitumen compound extruder comprises a gear pump and a barrel for containing a supply of the bitumen compound.

17. A system according to claim 16, wherein the bitumen compound is recirculated by the gear pump into the barrel when delivery of the bitumen compound to the die is not in demand.

18. A system according to claim 15, wherein the bituminous material extruder comprises a forming and cooling barrel at its outlet end.

19. A system according to claim 15, further comprising:
a bituminous material mixing and cooling tank for supplying cooled bituminous material into the bituminous material extruder.

20. A system according to claim 19, wherein the mixing and cooling tank comprises a ram and multi-pistons, which is operable to agitate the content to ensure homogenous mixing and increased cooling.

21. A system according to claim 11, further comprising a water bath cooling unit, which is disposed downstream of the weld press.

22. A composition of a bitumen compound film for wrapping a block of bituminous material, said composition comprising:
substantially 10 to 30% by weight of natural bitumen;
substantially 5 to 25% by weight of synthetic rubber polymer; and
the balance being the bituminous material of said block.
